(19) United States
(12) Patent Application Publication
(10) Pub. No.: US 2007/0031184 A1
(43) Pub. Date: Feb. 8, 2007

(54) Connector

(76) Inventor: Luke J. Baxstrom, Lewis, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 11/195,256

(22) Filed: Aug. 2, 2005

(51) Int. Cl. F16B 7/10

(52) U.S. Cl. 403/109.3

(57) ABSTRACT

A connector for attaching a first tubular member to a second tubular member wherein the first tubular member has at least one aperture and the second tubular member has at least one hole. The connector comprises a central member; at least one arm extending from the central member; at least one bolt having a socket, the at least one arm extending into the socket; and at least one biasing member between the central member and the bolt through which biasing member the at least one arm extends. The connector is resiliently biased by the at least one biasing member toward an extended position, such that the bolt extends through the aperture in the first tubular member and the hole in the second tubular member when the first tubular member is inserted into the second tubular member and the aperture and the hole are aligned.

### BACKGROUND OF THE INVENTION

1. Field of the Invention

The present invention relates generally to connectors and more particularly to a connector for reversibly connecting a first tubular member to a second tubular member, wherein the connector is supported within the first tubular member.

2. Discussion of the Background

Many types of products are assembled using tubular components that must be connected to one another or to a bracket or other device. The reversible connection of a first tubular member to a second tubular member has long been sought. It has also been found desirable to enable users repeatedly to assemble and disassemble some products in order to use the product. For example, trailer hitches are often used to connect a trailer to a vehicle; however, the user may not want the trailer permanently connected to the vehicle, or may want to connect a different type of trailer or device (such as a bicycle or ski rack) to the vehicle.

For tubular members that do not carry fluids, a simple method of attaching the tubular members together is to provide holes in the sides of the tubular members, insert an end of the first tubular member into an end of the second tubular member until the holes are aligned, and then insert a short, solid metal cylinder or connector through the aligned holes of the tubular members. One end of the securing connector is often bent so that the connector is partially secured in the holes.

However, this type of securing device can be disadvantageous. For instance, during use of a product or device in which the tubular members are so connected, the securing connector can suffer great perpendicular and vibration forces. As a result the connector can become disengaged from the holes, thus causing the tubular members to become separated. Depending on the use to which the attached tubular members are being put, for example, as a trailer hitch, such a separation can result in extremely dangerous hazards.

It is known within the art to extend a small connector through a connector hole formed at the straight end of the securing connector to prevent the disengagement of the securing connector. However, the small connector can often break and/or become disengaged itself, thereby eliminating any additional securing benefit. An additional disadvantage is that both connectors must be completely removed from their respective openings in order to remove the first tubular member from the second tubular member. As a result, this method is time consuming and thus inefficient. Moreover, because the securing connector is not an integral part of the first tubular member, the connector is often lost or misplaced.

Attempts have been made to remediate these disadvantages. For example, in the context of connecting tubular members, U.S. Patent Publication No. 2003/0215283 teaches a positioning device including a mounting block and two spring-loaded retainers. The mounting block is disposed in an inner tubular member, which can then be inserted into an outer tubular member. The spring-loaded retainers are biased to extend out of aligned holes in the outer and inner tubular members.

In the context of trailer hitches, several securing connectors have been disclosed. For example, U.S. Pat. No. 5,730,456 discloses a pair of locking bolts inside a trailer hitch tubular member. The locking bolts are spring biased outwardly through holes in the tubular member. The locking bolts can be moved inwardly toward one another manually to install the tubular member in the receiver. The bolts snap outward automatically when they are aligned with the holes in the receiver. The walls of one locking bolt slide within the walls of the other locking bolt, holding the bolts in place inside the inner tubular member.

U.S. Publication No. 2004/0240934 teaches a set of engagement connectors for securing a coupler to a receiver. A locking mechanism is coupled to the engagement connectors. The locking mechanism moves the engagement connectors to and from an extended position and a retracted position. The engagement connectors are cylinders held apart by a single spring, which biases the connectors outward toward the extended position. The spring is not necessary to move the connectors outward toward the extended position, but provides additional security in maintaining the connectors in the extended position. Two small extensions extending from each connector fit into slots on a lever attached to the locking cylinder. When the lever moves back and forth, the extensions in the slots move the connectors toward or away from each other. The connectors cannot be moved except via the lever. The lever can also include a blocker that can be extended in between the connectors when the connectors are extended, preventing any manual movement of the connectors to the retracted position. In another embodiment, a cam is used to rotate the extensions, causing the connectors to extend or retract.

U.S. Pat. No. 6,598,897 discloses two engagement connectors having a cylindrical shape with a block attached to one end. The connector sits within a recess in the block. A spring is slid onto the body of the connector toward the block such that the end of the spring is held inside the recess between the connector and the block. The connectors are placed inside the hitch with their blocks facing each other. A cam extends between the two blocks. A knob is used to slide the cam back and forth, between the blocks, forcing them apart against the tension of the springs, which are biased to force the blocks against the cam and retract the connectors. This sliding forward of the cam causes the connectors to extend. The cam is tensioned by another spring to preferably slide forward and extend the connectors. In another embodiment, the cam is moved by a drive gear actuated by turning a knob. Conceivably, the connectors could be retracted by pushing against the ends of the connectors and thus pushing the cam back away from the blocks. In another embodiment, the cam rotates against the blocks, pushing them apart.

In U.S. Pat. No. 6,910,719, a connecting device is shown having multiple parts, sleeves, and connectors.

In these prior methods fairly complicated connector devices having multiple parts are inserted permanently into the first tubular member. Should any one of the parts become disabled or break, the entire connector is rendered useless and must be replaced. This may be difficult should the connector device malfunction while the first tubular member is inserted into the second tubular member. Such complicated connector devices also increase the cost of the connector and increase the difficulty of using the connector.

In another context, contractors often need to connect different working devices, such as buckets or harrows, for example, to the operating arm of, for example, a backhoe or a tractor. In these environments, it is often brackets, plates, or hooks that need to be connected rather than tubular members. In some instances, a straight connector can also be used to make these types of connections, especially when the brackets or plates have holes therein.

In this context, for example, U.S. Pat. No. 6,231,296 illustrates a device for detachable coupling of an implement to an operating arm of an excavator. The device comprises, among other elements, a locking member with a hydraulic cylinder having double pistons with piston rods. The pistons are pressurized such that they preferably extend the piston rods so that they lock the locking member onto hooks on a locking element (see FIGS. 2 and 4). This device depends on a complex hydraulic circuit and control unit to operate. A similar device is shown in U.S. Pat. No. 6,513,268 and this device also depends on hydraulics to extend the pistons into the bolt holes. These types of devices are fairly complex and may be prone to breakage of the hydraulic circuitry that runs them. Multiple attachment points are used to connect the implement to the operating arm in addition to the connection through the hooks and holes.

It is therefore readily apparent that a new and improved connector for reversibly attaching a first tubular member to a second tubular member or for reversibly attaching other types of connectable members is needed that adequately secures the members, reduces the likelihood of dangerous accidental disengagements, is generally disposed within or connected to one of the tubular members or connectable members so that it is readily available, and can be easily secured or unsecured thereto. It is, therefore, to the provision of such an improvement that the present invention is directed.

### SUMMARY OF THE INVENTION

Briefly described, the present invention both overcomes the above-mentioned disadvantages, and meets the recognized needs for such a device, by providing a connector and method for reversibly connecting tubular members or other connectable members with an extendable, self-supporting connector.

The present invention is drawn to a connector that is reversibly inserted into a first tubular member of a connection assembly. The connector can maintain the relative positions of concentrically nested or telescopically related first (inner) and second (outer) tubular members. The connector can also be used to connect pairs of brackets or brackets and hooks. The connector can be used for assembling many types of apparatus such as but not limited to trailer hitches and other items connected to vehicles and vehicle trailer hitches (for example, bicycle carriers; truck bed extensions; motorcycle carriers; all-terrain vehicle hitches, storage boxes, fuel and water packs; hitch steps and ramps; hitch platforms and carriers; luggage racks) construction equipment, children's products such as play sets, strollers, swings, and toys, and other types of furniture, transports, and accessories.

The connector comprises a central member; at least one arm extending from the central member; at least one bolt having a socket; the at least one arm extending into the socket of the bolt; at least one biasing member between the central member and the bolt through which biasing member the at least one arm extends; wherein the bolt is resiliently biased by the at least one biasing member toward an extended position.

The connector in more detail comprises a central member; a first arm extending from the central member; a second arm extending from the central member opposite to the first arm; a first bolt having a first socket, the first arm extending into the socket; a second bolt having a second socket, the second arm extending into the second socket; a first biasing member between the central member and the first bolt, the first arm extending through the biasing member; a second biasing member between the central member and the second bolt, the second arm extending through the biasing member; wherein the connector is resiliently biased by the first and second biasing members toward an extended position.

The connector can be used with a connection assembly comprising a hollow first tubular member configured to be inserted into a second hollow tubular member having a hole, the first tubular member including at least one aperture through its side; at least one extendable connector supported by the hollow first tubular member and disposed at least partially within the hollow first tubular member, the at least one extendable connector being aligned with and extending through the at least one aperture; wherein the extendable connector comprises a central member; at least one arm extending from the central member; at least one bolt having a socket; the at least one arm extending into the socket of the bolt; the at least one bolt reversibly extending through the aperture and the hole.

The connector can also be used with a connection apparatus comprising a first pair of brackets having an aperture in each bracket, each bracket having an inside side and an outside side; a second pair of brackets having a hole in each bracket, the holes aligned with the apertures in the first pair of brackets when the second pair of brackets abuts the outside sides of the first pair of brackets; a connector extending between the first pair of brackets, the connector comprising a central member; at least one arm extending from the central member; at least one bolt having a socket, the at least one arm extending into the socket; at least one biasing member between the central member and the bolt; wherein the connector is resiliently biased by the at least one biasing member toward an extended position, such that the at least one bolt extends through the apertures in the first pair of brackets and the holes in the second pair of brackets.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements and refer to like elements throughout, and in which:

FIG. 1 is a perspective view of the connector of the present invention.

FIG. 2 is an exploded view of the connector shown in FIG. 1.

FIG. 3 is an end view of the bolt along line 3-3 of FIG. 2.

FIG. 4 is a cross-sectional view of the bolt along line 4-4 of FIG. 3.

FIG. 5 is a partial perspective view of the first tubular member inserted into the second tubular member and held with a connector.

FIG. 6 is a partial perspective view of the first tubular member of the present invention.

FIG. 7 is a partial perspective view of the first tubular member with a connector therein.

FIG. 8 is a partial perspective view of the second tubular member.

FIG. 9 is a perspective view of the connector when used for attaching a towing device affixed to a vehicle.

FIG. 10A is a perspective view of the first tubular member and connector when used for attaching a towing device.

FIG. 10B is a partial perspective view of the first tubular member when used for attaching a towing device.

FIG. 11 is a top view of the first tubular member entering the second tubular member when used for attaching a towing device showing the connector in a compressed position.

FIG. 12 is a top view of the first tubular member inserted in the second tubular member when used for attaching a towing device showing the connector in an extended position.

FIG. 13 is a partial perspective view of the connector when used with brackets.

### DETAILED DESCRIPTION OF THE INVENTION

In describing the present invention illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

With regard to all such embodiments as may be herein described and contemplated, it will be appreciated that optional features, including, but not limited to, aesthetically pleasing coloration and surface design, and labeling and brand marking, may be provided in association with the present invention, all without departing from the scope of the invention.

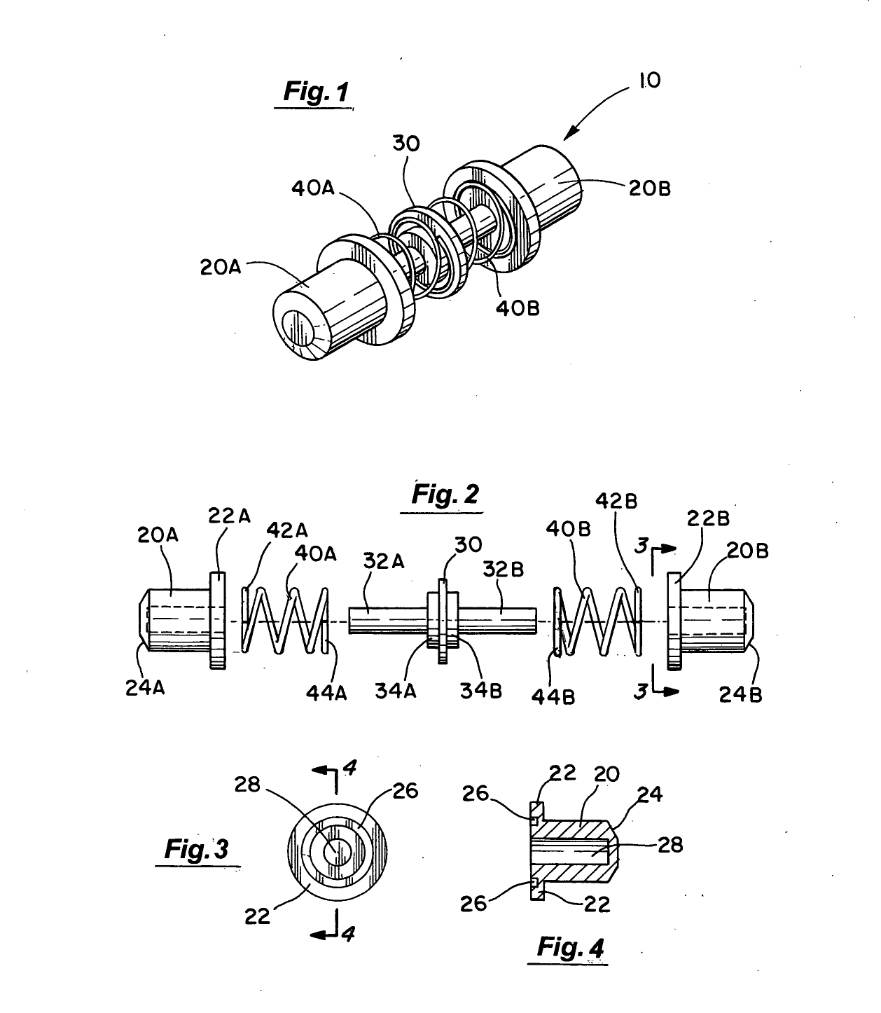

Referring now to the drawings, wherein identical numerals indicate like parts, and initially to FIGS. 1-4, a connector 10 comprises at least one bolt 20 and in one embodiment comprises a first bolt 20A and a second bolt 20B. The connector 10 further comprises a central member 30 located between the bolts 20A, 20B. At least one biasing member 40 is positioned between the at least one bolt 20 and the central member 30. In one embodiment as illustrated in FIG. 1, the at least one biasing member 40 is a spring. However, other types of biasing members appropriate for the practice of the present invention will be readily evident to those skilled in the art and are meant to be included in the present invention.

FIG. 2 illustrates an exploded view of the connector 10. The central member 30 comprises at least one arm 32 extending outwardly therefrom. In one embodiment, the at least one arm 32 maintains a coaxial relationship with the central member 30. At least one flange 34 is located between the central member 30 and the at least one arm 32, and the at least one flange 34 is an integral part of the central member 30. The at least one arm 32 extends through the at least one biasing member 40.

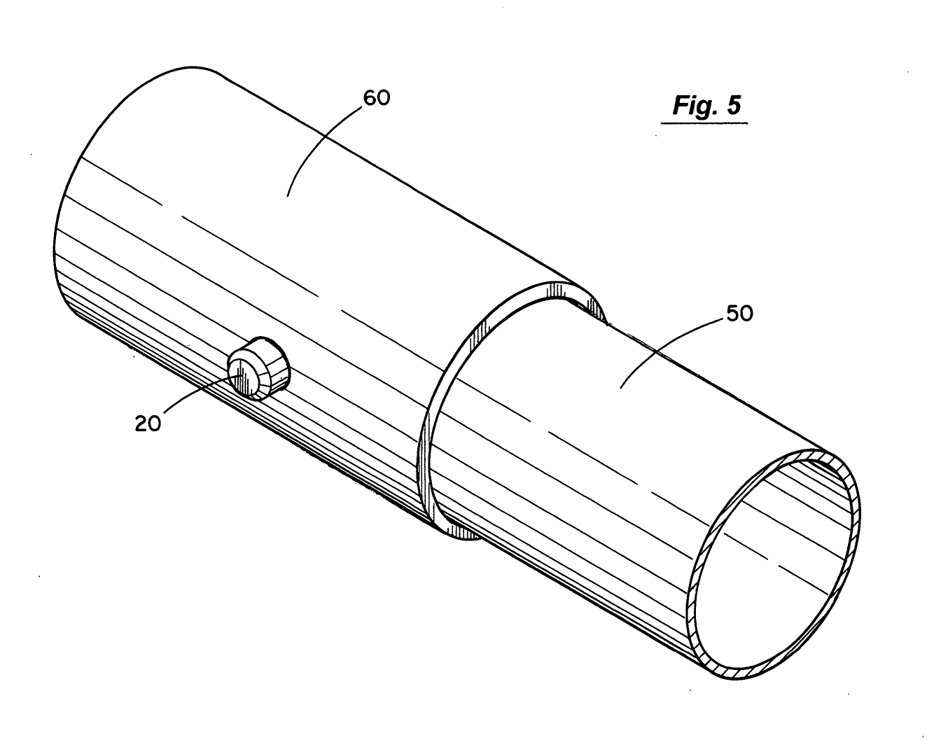

The structure of the at least one bolt 20 is shown in more detail in FIGS. 3 and 4. The bolt 20 is generally cylindrical and has a detente 22 attached to the proximal end thereof. The distal end 24 of the bolt 20 is beveled, as shown in FIGS. 2 and 4. FIG. 3 illustrates the proximal end of the bolt 20. An annular groove 26 is formed in the detente 22 facing the central member 30. A socket 28 is formed inside the bolt 20. The socket 28 is coaxial with the arm 32 and the central member 30 when the connector 10 is assembled as described below.

When the connector 10 is assembled, the at least one biasing member 40 is placed over the at least one arm 32. The distal end 42 and the proximal end 44 of the biasing member 40 are generally flattened. The flattened proximal end 44 has a diameter that is slightly greater than the diameter of the flange 34. Thus, the proximal end 44 of the biasing member 40 fits closely around the edge of the flange 34 and thus is supported on the central member 30 without undue sideways motion.

The at least one arm 32 of the central member 30 is then inserted into the socket 28 of the at least one bolt 20. The diameter of the socket 28 is just slightly larger than the diameter of the arm 32; thus, the arm 32 fits securely but not tightly into the socket 28. As the bolt 20 slides down onto the arm 32, the flattened distal end 42 of the biasing member 40 fits into the groove 26 on the proximal end of the bolt 20. Thus, the biasing member 40 is supported between the groove 26 of the bolt 20 and the flange 34 of the central member 30 such that the biasing member 40 does not touch the arm 32, which extends coaxially through the biasing member 40 and into the socket 28 of the bolt 20.

In one embodiment as illustrated in FIG. 2, the connector 10 comprises a mirror image arrangement in which the central member 30 comprises a first arm 32A and a second arm 32B extending outwardly and coaxially in opposite directions therefrom. A first flange 34A and a second flange 34B are located between the central member 30 and each respective arm 32A, 32B. A first biasing member 40A and a second biasing member 40B are positioned between the central member 30 and the respective bolts 20A, 20B. The first arm 32A and the second arm 32B extend through the respective biasing members 40A, 40B.

The connector 10 is resiliently biased by the at least one biasing member 40 toward an extended position, the use of which bias is described in more detail below.

Although the present invention has been described standing alone, the connector 10 can be used to attach any two tubular members together in a connection assembly, as shown in FIG. 5, wherein an end 14 of a first tubular member 50 in which the connector 10 is supported is sized to be inserted into an end 62 of a second tubular member 60. For convenience, the tubular members of the present invention are illustrated as being circular in cross section; however, it should be understood that the tubular members can have any conventional cross-sectional shape, for example but not limited to circular, ellipsoid, square, rectangular, triangular, or any conventional geometric shape that would enable the invention to be practiced as described herein.

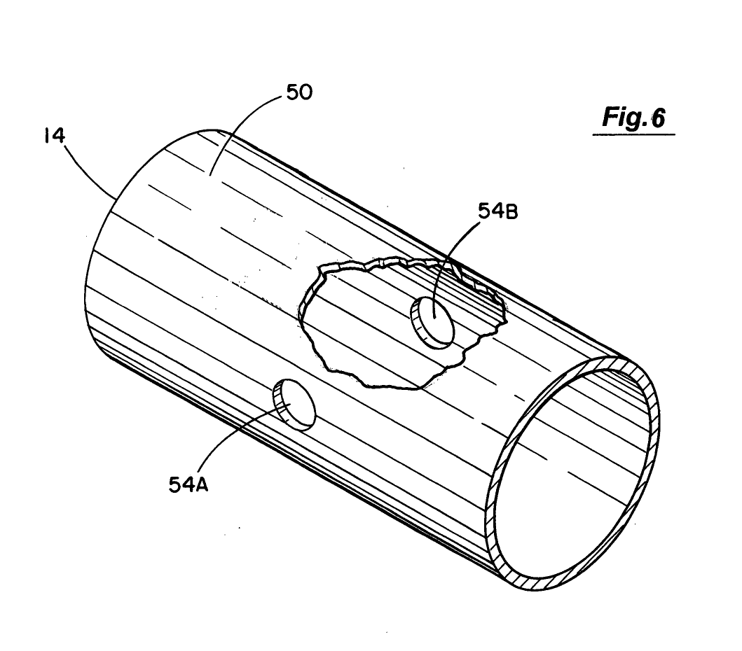

The first tubular member 50 is shown in more detail in FIG. 6. The first tubular member has at least one end 14, which can be inserted into a second tubular member 60. At least one aperture 54A is placed into the side of the first tubular member 50. In another embodiment, for use with the mirror image embodiment of the connector 10, a second aperture 54B is placed diametrically opposite the first aperture 54A such that the two apertures 54A, 54B are aligned.

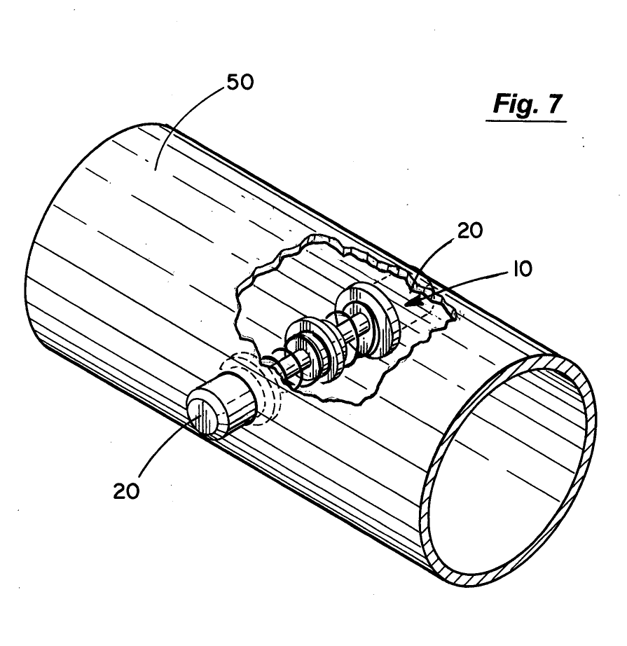

After the connector 10 is assembled in a mirror image embodiment as shown in FIG. 2, it is inserted into the first tubular member 50 as shown in FIG. 7. To insert the connector, the connector 10 is first compressed to its full extent, for example, by pressing against the bolts 20A, 20B with the fingers and thumb of the hand such that the proximal ends of the bolts 20A, 20B slide along the arms 32A, 32B and approach the central member 30. Once the connector 10 is compressed sufficiently, the connector 10 is inserted through an opening at the end 14 of the first tubular member 50. The distal ends 24A, 24B of the bolts 20A, 20B are then inserted into the respective aligned apertures 54A, 54B in the first tubular member 50. The beveled edges 24A, 24B of the bolts 20A, 20B assist in easing the insertion of the bolts 20A, 20B into the apertures 54A, 54B. Once the distal ends 24A, 24B of the bolts 20A, 20B are inserted into the apertures 54A, 54B, the connector 10 is released. Because the biasing members 40A, 40B bias the bolts 20A, 20B away from the central member 30, the connector 10 automatically extends, inserting the distal ends 24A, 24B of the bolts 20A, 20B firmly into the apertures 54A, 54B.

The connector 10 is designed such that when it is inserted into the first tubular member 50 and extends into the apertures 54A, 54B as describe above, it is self-supporting within the first tubular member 50. This occurs because when the connector 10 extends due to the bias of the biasing members 40A, 40B pushing the bolts 20A, 20B away from the central member 30 and into the apertures 54A, 54B, the détentes 22A, 22B of the bolts 20A, 20B abut the first tubular member 50 around the apertures 54, preventing the connector 10 from extending fully. The biasing members 40A, 40B thus maintain a constant tension on the bolts 20A, 20B and the central member 30. The central member 30 is further supported by the arms 32A, 32B extending partway into the sockets 28 of the bolts 20A, 20B at all times when the connector 10 is thus extended. Because the connector 10 is self-supporting within the first tubular member 50, it can be left within the first tubular member 50 when the first tubular member 50 is not in use and will therefore not be inadvertently misplaced or lost. The self-supporting nature of the connector 10 also permits the first tubular member 50 to be used in any desired orientation without risking any unexpected disengagement of the connector 10.

When it is desired to remove (not shown) the connector 10 from the first tubular member 50, the connector 10 need only be compressed until the distal ends 24A, 24B of the bolts 20A, 20B no longer extend through the apertures 54, at which point the connector 10 can be easily removed from the first tubular member 50 through the opening 14.

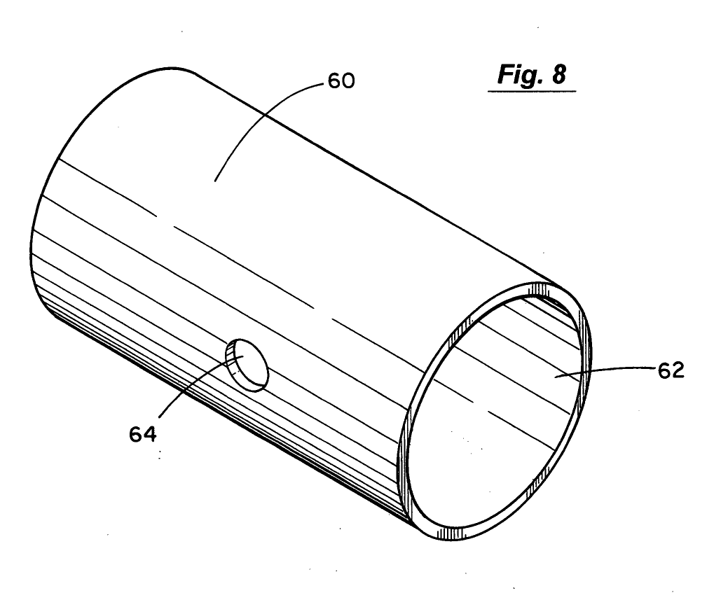

After the connector 10 is inserted into the first tubular member 50, the end 14 of the first tubular member 50 can then be inserted into the end 62 of the second tubular member 60. The second tubular member 60 is illustrated in more detail in FIG. 8. The second tubular member 60 is generally hollow and has an open end 62. The second tubular member 60 is sized such that the end 14 of the first tubular member 50 fits snugly into the end 62. A first hole 64A is placed into the side of the second tubular member 60. In another embodiment, for use with the mirror image embodiment of the connector 10, a second hole 64B is placed diametrically opposite the first hole 64A such that the two holes 64A, 64B are aligned. The placement of the holes 64 is such that when the first tubular member 50 is inserted into the second tubular member 60, the apertures 54 of the first tubular member 50 can be aligned, thus allowing the bolts 20 to extend out of the holes 64, holding the first tubular member 50 securely within the second tubular member 60.

It is to be understood that the other ends of the tubular members 50, 60 can be attached to any desired device or can stand alone. For example, the tubular members 50, 60 can be attached to a vehicle and a trailer hitch, to a rack that is attached to the top or side of a vehicle, to a lamp that is affixed thereby to a post or grill, or any other devices in which one piece is reversibly attached to another piece. Alternatively, the tubular members 50, 60 can be used as part of children's play sets or toys, supports for shelters, an umbrella attached to a table or wall, or any other device in which tubular members are reversibly inserted one into the other. Many uses will be obvious to those skilled in the art and are meant to be included in the scope of the invention.

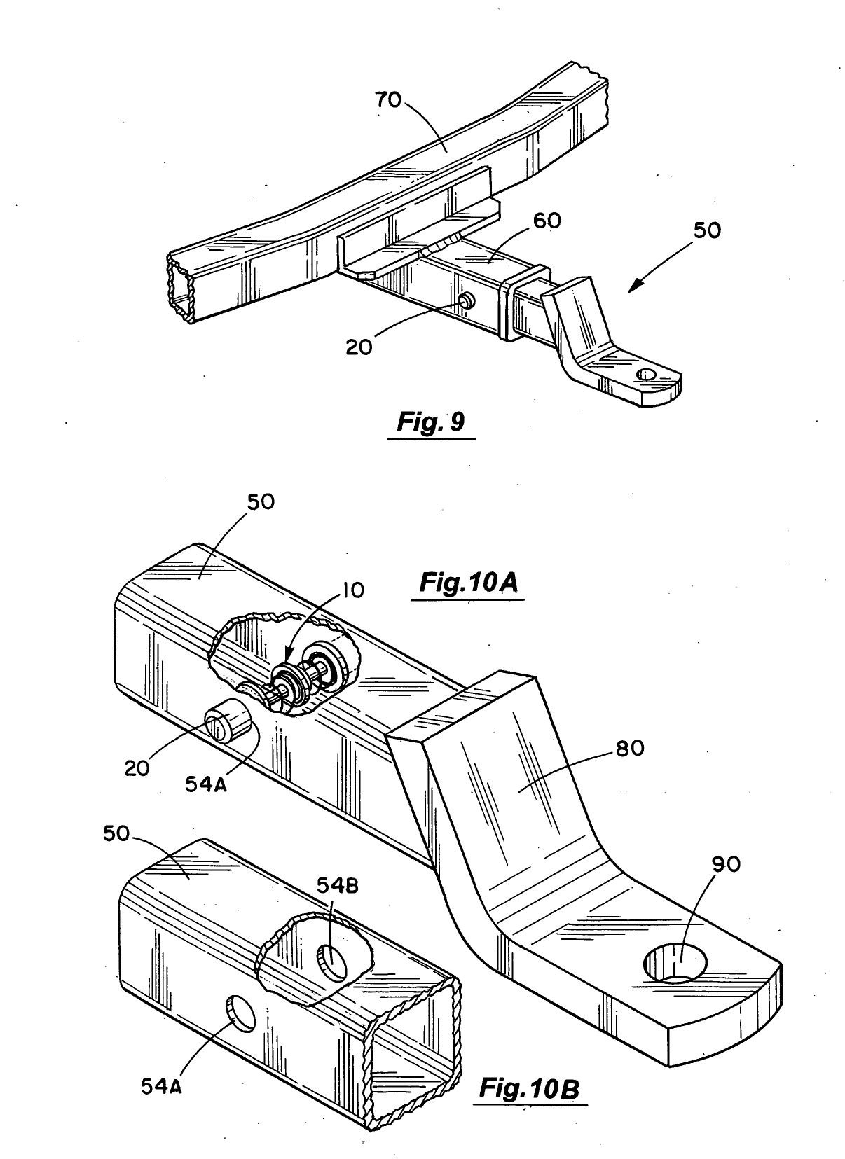

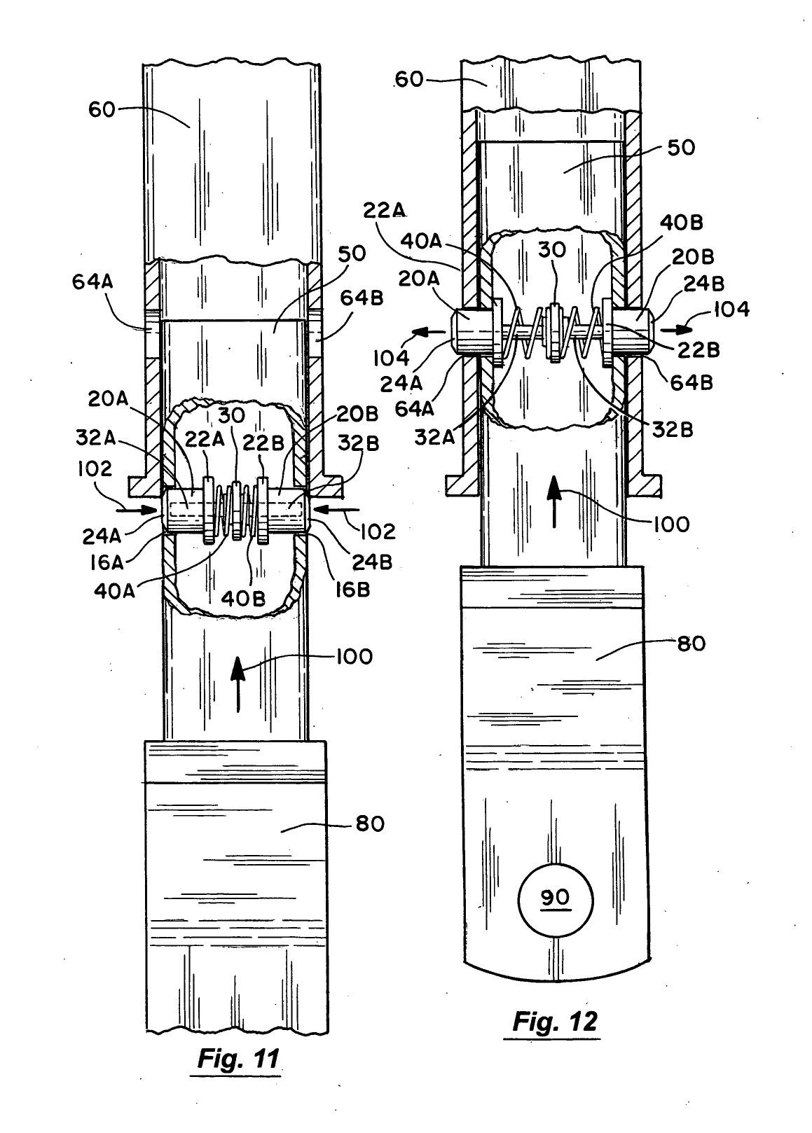

An example of a first tubular member 50 being inserted into a second tubular member 60 for use in a particular apparatus is illustrated in FIGS. 9-12. In this embodiment, the tubular members 50, 60 form a trailer hitch to attach a trailer to a vehicle. The apparatus is shown generally in FIG. 9 and comprises a first tubular member 50, a connector 10 of which only the bolt 20 can be seen, and a second tubular member 60. The second tubular member 60 is attached securely to a vehicle under the rear bumper 70. More specifically, in this particular embodiment, the second tubular member 60 is a hollow, elongated rectangular cross-sectional shaped member defined by four walls at right angles. Holes 64A, 64B (see FIG. 11) are formed in two opposing walls of the second tubular member and are aligned.

As shown in more detail in FIGS. 10A and 10B, the trailer hitch comprises a first tubular member 50 to which is attached a ball mount plate 80. The ball mount plate 80 contains a hole 90 formed in the distal end thereof to which is typically attached a ball mount (not shown) on which the trailer connection of the trailer is placed for towing. In more detail, the first tubular member 50 is a hollow, elongated member with a rectangular cross-section defined by sides. A first aperture 54A is placed into a side of the first tubular member 50. For use with the mirror image embodiment of the connector 10 as described above, a second aperture 54B is placed diametrically opposite the first aperture 54A such that the two apertures 54A, 54B are aligned, as shown in FIG. 10B. The connector 10 is supported inside the first tubular member 50 as shown in FIG. 10A and described in more detail above. The first tubular member 50 is sized to fit snugly inside the second tubular member 60 when the end 14 of the first tubular member 50 is inserted into the end 62 of the second tubular member 60.

After the connector 10 is inserted into the first tubular member 50 as described above, the first tubular member 50 can be connected to the second tubular member 60 for use as a trailer hitch. FIGS. 11 and 12 illustrate the method of connecting the first tubular member 50 to the second tubular member 60. As described above, the first tubular member 50 and the second tubular member 60 have generally the same rectangular shape; however, the first tubular member 50 is sized slightly smaller, such that the end 14 of the first tubular member 50 can be inserted 100 telescopically into the end 62 of the second tubular member 60. To do this, the connector 10 is first compressed 102 slightly, until the beveled edges 24A, 24B of the bolts 20A, 20B more or less align with the edges of the apertures 54, as shown in FIG. 11. The end 14 of the first tubular member 50 is then inserted (as shown by arrow 100) into the end 62 of the second tubular member 60. When the beveled edges 24A, 24B of the bolts 20A, 20B meet the end 62 of the second tubular member 60, the end 62 slides smoothly over the beveled edges 24A, 24B, further compressing the connector 10, as shown by arrows 102, fully inside the apertures 54A, 54B of the first tubular member 50, but still supported by the sides of the first tubular member 50. The first tubular member 50 is then further inserted 100 into the second tubular member 60 until the bolts 20A, 20B align with the holes 64A, 64B in the second tubular member 60. Because of the extension bias 104 provided by the biasing members 40A, 40B, the bolts 20A, 20B then automatically extend through the holes 64A, 64B, as shown by arrows 104, until the détentes 22A, 22B on the proximal ends of the bolts 20A, 20B abut the sides of the first tubular member 50. Thus, the connector 10 automatically extends into place to hold the first tubular member 50 securely inside the second tubular member 60, ready for the towed trailer to be attached.

To disconnect (not shown) the first tubular member 50 from the second tubular member 60, the above process is simply reversed. Once again, the connector 10 is compressed sufficiently until the beveled edges 24A, 24B of the bolts 20A, 20B more or less align with the inside edges of the holes 64A, 64B in the second tubular member 60. The first tubular member 50 is then pulled out of the second tubular member 60, the beveled edges 24A, 24B of the bolts 20A, 20B sliding along the sides of the second tubular member 60. After the bolts 20A, 20B clear the end 62 of the second tubular member 60, the biasing members 40A, 40B cause the bolts 20A, 20B to extend outward again, automatically supporting the connector 10 inside the first tubular member 50.

During the entire insertion and removal process, the arms 32A, 32B of the central member 30 remain inside the sockets 28 of the bolts 20A, 20B. The compression of the connector 10 is never so great that the bolts 20A, 20B are in any danger of inadvertently slipping out of the apertures 54A, 54B in the first tubular member 50. In fact, the connector 10 is securely maintained in its insertion into the apertures 54A, 54B by the extension bias of the biasing members 40A, 40B pushing the bolts 20A, 20B against the sides of the second tubular member 60 as the first tubular member 50 is being withdrawn.

In general, then, the invention provides a method for attaching a first tubular member having at least one aperture near an end to a second tubular member having at least one hole near an end, the method comprising inserting at least one connector into the first tubular member, the at least one connector extending through the at least one aperture such that it extends transversely across the interior of the first tubular member; wherein the connector comprises a central member; at least one arm extending from the central member; at least one bolt having a socket, the at least one arm extending into the socket; at least one biasing member between the central member and the bolt such that the connector is resiliently biased by the at least one biasing member toward an extended position; compressing the at least one connector; inserting the end of the first tubular member into the end of the second tubular member; aligning the at least one hole in the second tubular member with the at least one aperture in the first tubular member; such that the at least one bolt extends through the at least one aperture in the first tubular member and the at least one hole in the second tubular member when the first tubular member is inserted into the second tubular member; the at least one bolt extending through the at least one aperture and the at least one hole when the at least one aperture and the at least one hole are aligned.

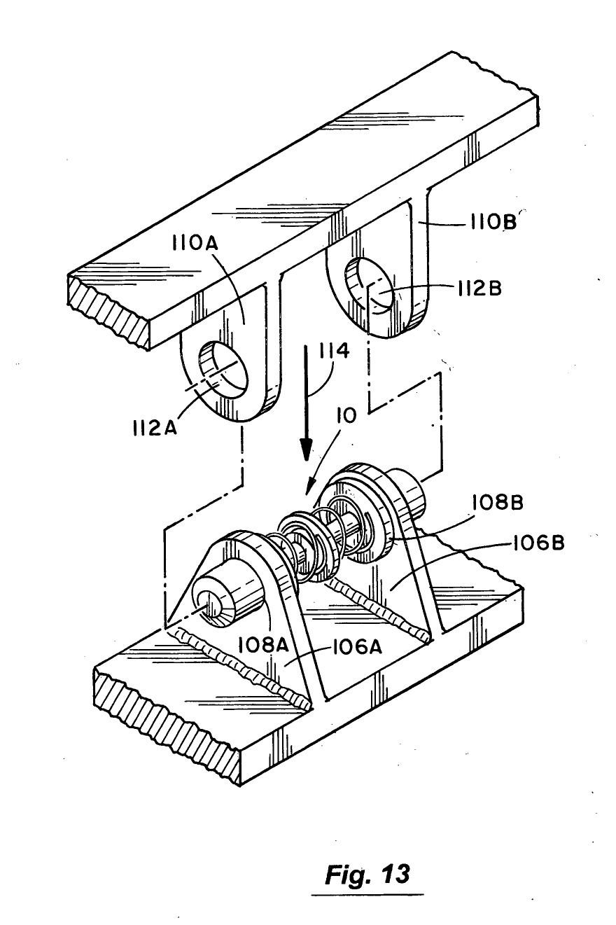

Another embodiment of the present invention is illustrated in FIG. 13. In this embodiment of a connection apparatus, the connector 10 is used to connect a first pair of brackets 106A, 106B to a second pair of brackets 110A, 110B. In this specification, the term “brackets” is defined to include any device that supports having a hole therein, whether complete or incomplete, such as a hook shape. The connector 10 can be used in its mirror image embodiment as described above. The connector 10 is inserted into aligned apertures 108A, 108B in the first pair of brackets 106A, 106B, and is self-supporting therein in the same manner as described above in which the connector 10 is inserted within a first tubular member 50. The second pair of brackets 110A, 110B has aligned holes 112A, 112B therein. The first 106A, 106B and second 110A, 110B pairs of brackets can be respectively attached to any devices that are desired to be reversibly connected, for example, but not limited to, construction equipment operating arms and implementing devices. When it is desired to connect the two parts, the brackets 106, 110 are moved 114 toward each other. The second pair of brackets 110A, 110B are positioned such that each bracket 110A, 110B is situated just to the outside of each respective first bracket 106A, 106B, such that the inside sides of the second pair of brackets 110A, 110B abut the respective outside sides of the first pair of brackets 106A, 106B. The connector 10 is first slightly compressed until the edges of the second pair of brackets 110 slide over the beveled edges 24 of the bolts 20 as the second pair of brackets 110 slides over the first pair of brackets 106. When the holes 112 in the second pair of brackets 110 become aligned with the apertures 108 in the first pair of brackets 106, the extension bias provided by the biasing members 40A, 40B automatically extends the bolts 20A, 20B through the holes 112A, 112B, until the détentes 22A, 22B on the proximal ends of the bolts 20A, 20B abut the inside sides of the first pair of brackets 106. Disconnection of the brackets 106, 110 is done by the same method described above for tubular members.

Thus, a connection apparatus comprises a first pair of brackets having an aperture in each bracket, each bracket having an inside side and an outside side; a second pair of brackets having a hole in each bracket, the holes aligned with the apertures in the first pair of brackets when the second pair of brackets abuts the outside sides of the first pair of brackets; a connector extending between the first pair of brackets, the connector comprising a central member; at least one arm extending from the central member; at least one bolt having a socket, the at least one arm extending into the socket; at least one biasing member between the central member and the bolt; wherein the connector is resiliently biased by the at least one biasing member toward an extended position, such that the at least one bolt extends through the apertures in the first pair of brackets and the holes in the second pair of brackets.

In another embodiment, the second pair of brackets is in the form of hooks.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A connector comprising:
a central member;
at least one arm extending from the central member;
at least one bolt having a socket, the at least one arm extending into the socket;
at least one biasing member between the central member and the bolt, wherein the connector is resiliently biased by the at least one biasing member toward an extended position.

2. The connector of claim 1 wherein the at least one biasing member comprises a spring through which the at least one arm extends.

3. A connector comprising:
a central member;
a first arm extending from the central member;
a second arm extending from the central member opposite to the first arm;
a first bolt having a first socket, the first arm extending into the socket;
a second bolt having a second socket, the second arm extending into the second socket;
a first biasing member between the central member and the first bolt, the first arm extending through the biasing member;
a second biasing member between the central member and the second bolt, the second arm extending through the biasing member;
wherein the connector is resiliently biased by the first and second biasing members toward an extended position.

4. The connector of claim 3 wherein the first biasing member and the second biasing member are springs.

5. A connection apparatus comprising:
a first tubular member having at least one aperture;
a second tubular member having at least one hole and having an open end sized to receive an end of the first tubular member, the at least one aperture and the at least one hole becoming aligned when the end of first tubular member is inserted into the open end of the second tubular member;
a connector disposed within the first tubular member, the connector comprising:
a central member;
at least one arm extending from the central member;
at least one bolt having a socket, the at least one arm extending into the socket;
at least one biasing member between the central member and the bolt;
wherein the connector is resiliently biased by the at least one biasing member toward an extended position, such that the at least one bolt extends through the at least one aperture in the first tubular member and the at least one hole in the second tubular member when the first tubular member is inserted into the second tubular member.

6. The apparatus of claim 5 wherein the at least one biasing member comprises a spring through which the at least one arm extends.

7. The apparatus of claim 6 wherein the first tubular member includes two apertures and the second tubular member includes two holes that are configured to be aligned with the apertures when the first tubular member is inserted into the second tubular member.

8. The apparatus of claim 7 wherein the two apertures of the first tubular member are disposed on opposite sides of the first tubular member and the two holes of the second tubular member are disposed on opposite sides of the second tubular member.

9. A method for attaching a first tubular member having at least one aperture near an end to a second tubular member having at least one hole near an end, the method comprising:
inserting at least one connector into the first tubular member, the at least one connector extending through the at least one aperture such that it extends transversely across the interior of the first tubular member;
wherein the connector comprises:
a central member;
at least one arm extending from the central member;
at least one bolt having a socket, the at least one arm extending into the socket;
at least one biasing member between the central member and the bolt such that the connector is resiliently biased by the at least one biasing member toward an extended position;
compressing the at least one connector;
inserting the end of the first tubular member into the end of the second tubular member;
aligning the at least one hole in the second tubular member with the at least one aperture in the first tubular member;
such that the at least one bolt extends through the at least one aperture in the first tubular member and the at least one hole in the second tubular member when the first tubular member is inserted into the second tubular member and when the at least one aperture and the at least one hole are aligned.

10. A connection apparatus comprising:
a first pair of brackets having an aperture in each bracket, each bracket having an inside side and an outside side;
a second pair of brackets having a hole in each bracket, the holes aligned with the apertures in the first pair of brackets when the second pair of brackets abuts the outside sides of the first pair of brackets;
a connector extending between the first pair of brackets, the connector comprising:
a central member;
at least one arm extending from the central member;
at least one bolt having a socket, the at least one arm extending into the socket;
at least one biasing member between the central member and the bolt;
wherein the connector is resiliently biased by the at least one biasing member toward an extended position, such that the at least one bolt extends through the apertures in the first pair of brackets and the holes in the second pair of brackets.

11. The apparatus of claim 10 wherein the at least one biasing member comprises a spring through which the at least one arm extends.

12. The apparatus of claim 10 wherein the second pair of brackets is in the form of hooks.
